(19) United States
(12) Patent Application Publication
(10) Pub. No.: US 2003/0050575 A1
(43) Pub. Date: Mar. 13, 2003

(54) Device for obtaining at least one constituent of a bodily fluid

(76) Inventors: Ulrich Diermann, Ipsach (CH); Ulrich Haueter, Grosshochstetten (CH)

Correspondence Address: David E. Bruhn, DORSEY & WHITNEY LLP, Suite 1500, 50 South Sixth Street, Minneapolis, MN, 55402-1498, US

(21) Appl. No.: 10/229,904

(22) Filed: Aug. 27, 2002

Related U.S. Application Data
(63) Continuation of application No. PCT/CH01/00097, filed on Feb. 13, 2001.

(30) Foreign Application Priority Data
Feb. 29, 2000 (DE) DE 100 09 482.1

(51) Int. Cl. A61D 5/00

(52) U.S. Cl. 600/581

(57) ABSTRACT

The invention relates to a device for obtaining at least one constituent of a body fluid, using a cannula which projects from a lower side of the device and may be positioned in a body tissue, said device comprising a capillary layer having an exposed surface for evaporating the fluid and said cannula being connected to the capillary layer.

### PRIORITY CLAIM

This is a Continuation Application of International Application No. PCT/CH01/00097, filed on Feb. 13, 2001, which claims priority to German Application No. DE 100 09 482.1, filed on Feb. 29, 2000, both of which are incorporated herein by reference.

### BACKGROUND

The invention relates to a device and method for obtaining at least one constituent of a body fluid using a cannula which is or can be positioned in a body tissue. In some embodiments, the device is, in particular, a micro perfusion device or a micro filtration device.

In known devices for obtaining at least one constituent of a body fluid, the constituent to be obtained is transported from the body by means of a motor-driven pump. Pumps require energy and, for the most part, control systems as well.

### SUMMARY

It is an object of the invention to provide a device for obtaining at least one constituent of a body fluid using a cannula which is positioned in a body tissue, said device comprising a simple transport system for transporting the constituent from the body tissue.

The object is addressed by the device of the present invention which comprises a cannula for positioning in a body tissue and a capillary layer having an exposed surface, the cannula being connected to the capillary layer.

Fluid situated in the cannula is transported by capillary rise to the exposed surface of the capillary layer and there evaporated. The fluid is transported on by evaporation. Because of its function, the exposed surface of the capillary layer will be referred to in the following description as the evaporation area.

A capillary action of the capillary layer can be based on the fact that capillary channels which open toward the surface are incorporated into the evaporation area and generate the capillary rise. Preferably, however, the capillary layer comprises capillaries which extend through the capillary layer and through which the fluid is transported from the cannula to the evaporation area. In this case, the capillaries open onto the evaporation area.

The capillary action can be achieved in a micro system technique by incorporating micro channels into a suitable base material, for example, a silicon or a plastic material. The capillary action can also be achieved in a micro system technique directly in the manufacture of the base, for example by forming it in fine layers. In another embodiment, the capillary layer may comprise a fabric-like material, a fleece or a fabric, in particular a textile fabric, or it may contain at least one fleece and/or fabric component. A material having a statistical porosity is perfectly sufficient for the purposes of the invention.

The capillary layer is preferably arranged in the immediate vicinity of the cannula. The cannula can be directly connected to the capillary layer, for example anchored in the capillary layer. It then projects directly from a lower side of the capillary layer. The capillary layer can instead also be arranged on an upper side of a casing which simultaneously serves as a base for the cannula. In this case, the cannula projects from a lower side of the casing. The casing can be formed as a simple base substrate. In this case, the fluid is transported from the cannula directly into the capillary layer. A fluid connection from the cannula to the capillary layer can, however, also be formed in the casing. Advantageously, the fluid is already dispersed in the casing, before it enters the capillary layer.

The cannula can exhibit a sealed surface which is open at a cannula tip. In this case, the body fluid only penetrates into the cannula at the tip. Preferably, however, the surface of the cannula is permeable to the body fluid or at least to the constituent to be obtained. A cannula having a permeable surface can be manufactured from a porous material. Permeability can also be achieved by perforating the cannula. Openings or perforations in the cannula may be created or provided using suitable devices and methods, e.g., lasers, during the manufacture of the cannula or subsequently.

If the cannula is perforated, then the lateral perforation openings of the perfusion cannula are preferably elongated in the longitudinal direction of the catheter, in order to obtain as great a stability against straining as possible. Straining the catheter as it is inserted into the tissue, also known as peal back effect, is thus prevented or at least kept to a minimum. The perforation openings are preferably arranged on gaps or offset with respect to each other, not along a line extending in the longitudinal direction of the cannula but in the circumferential direction of the cannula.

The cannula can be formed by an injection needle which preferably exhibits a surface which is permeable in the above sense. Using just a cannula formed in this way and the capillary layer connected to it, a filtration device for obtaining the body fluid or at least the desired constituent can be formed.

If the cannula is flexible, then it is inserted into the tissue using an injection needle, and positioned in the tissue. If the device is a filtration device, then only the injection needle is removed after positioning, and capillary transport can begin.

In one embodiment, the device for obtaining the at least one constituent of the body fluid is formed by a micro perfusion device. A rinsing fluid, called perfusate, is supplied to the cannula and discharged via the evaporation area of the capillary layer. When embodied as a perfusion device, the device comprises a casing having a perfusate supply and preferably also a fluid connection from the cannula to the capillary system. In the case of perfusion, the cannula forms an outer cannula which surrounds another, inner cannula.

The inner cannula comprises two cannula openings. The cannula opening which is distal when the device is implanted, i.e., positioned in a patient's body, will be referred to as the front cannula opening, and the other cannula opening which, by contrast, is nearer the casing, will be referred to as the rear cannula opening. The inner cannula encloses an inner lumen between its front cannula opening and its rear cannula opening. The inner cannula and the surrounding outer cannula form a co-axial flow system comprising the inner lumen and an outer lumen between the inner cannula and the outer cannula. The perfusate is introduced by the perfusate supply through the rear cannula opening into the inner lumen, flows through the inner lumen, leaves the inner lumen through the front cannula opening into the surrounding outer lumen and flows in the outer lumen back towards the casing, enters an outlet into the casing and passes through the outlet into the capillary layer. Instead of via an outlet in the casing, the outer lumen can also feed directly into the capillary layer.

The perfusion device can be developed into an autonomic perfusion system by connecting the perfusate supply to a flexible perfusate storage container. Such a flexible storage container can advantageously be arranged on or in the casing. When the perfusate is transported by evaporation, the storage container contracts and so offers no resistance or at least no practically appreciable resistance to being emptied. The storage container is fluid-proof and preferably also air-tight.

In a preferred application, the device in accordance with the invention serves to measure or ascertain glucose concentration. In this case, the at least one constituent of the body fluid is glucose.

The inner cannula is particularly preferably an injection needle, for example a steel needle, which serves to position the outer cannula in the body tissue. In principle, however, the inner cannula can also be formed by a cannula which is not inserted until after the device has been positioned, as in conventional perfusion or dialysis devices.

In order to obtain an outer cannula which is as slim as possible, the outer cross-section of the inner cannula and the inner cross-section of the outer cannula preferably exhibit different shapes, preferably such that the outer cannula only abuts the inner cannula in longitudinal strips, and a longitudinal gap remains between adjacent longitudinal strips. In this form, the outer cannula can wrap tightly around the inner cannula along its entire length situated in the tissue. A flow cross-section for the perfusate flowing back nonetheless remains between the outer surface area of the inner cannula and the inner surface area of the outer cannula. In preferred example embodiments, either the inner cannula or the outer cannula exhibits a cross-section which deviates from the circular form. If, for example, the inner cannula exhibits an outer cross-section deviating from the circular form along its implanted length, then the outer cannula can exhibit a circular inner cross-section tensed around the needle. Equally, the outer cannula can exhibit a non-circular inner cross-section and the inner cannula a circular outer cross-section. However, it is also possible for the outer cross-section of the inner cannula and the inner cross-section of the outer cannula to deviate from the circular form, so long as it is ensured that a sufficient flow cross-section for the purpose of rinsing remains between the needle and the outer cannula and that the outer cannula surrounds the inner cannula, preferably wrapped tightly around it, for the purpose of securely implanting it.

In its rear sliding position, the inner cannula is preferably fixed to the casing in such a way that when the inner cannula is being moved into or is in its rear sliding position it can be tactilely sensed by someone using the micro perfusion device. The inner cannula can, for example, simply be moved into its rear sliding position against a stopper. The inner cannula is preferably fixed not only against sliding further, beyond the rear sliding position, but also against the inner cannula advancing, i.e., moving forward or backward. The inner cannula is preferably fixed to the casing in its rear sliding position by means of a locking connection, preferably a detachable locking connection. For fixing it, a protrusion, a dent, a slit or the like is preferably formed on the inner cannula. In one embodiment, the rear cannula opening is used for the purpose of the locking connection.

In one embodiment, the device is not only used to obtain the at least one constituent of the body fluid, but simultaneously serves as a miniature measuring means or at least as an electrode platform for a measuring means. The measuring means is suitable and serves to measure or ascertain the concentration of the at least one constituent in the body fluid. When used as an electrode platform, with or without an integrated measuring means, an electrode of the measuring means is formed on the csing, for example, on the lower side of the capillary layer of the casing, via which the device sits on the tissue. A working electrode of the measuring means is electrically connected to the discharged fluid. The working electrode is preferably arranged in an outlet of a casing or in the cannula, but outside the body tissue when positioned. The electrode formed on the lower side of the casing or capillary layer forms the counter electrode to this working electrode and serves to measure an electrical current and/or an electrical potential. Preferably, a sufficiently large bearing area is formed on the lower side for the counter electrode to be able to form a sufficiently large contact area with the tissue and simultaneously be used as a reference electrode. Furthermore, it can fulfill an adhesive function, for adhering to the skin.

When the device of the present invention is formed as a miniature measuring means, a sensor is arranged in the capillary layer, in the cannula connected to the capillary layer, or in a casing of the device, for measuring the concentration of the at least one constituent in the body fluid. More precisely, the concentration in the fluid transported to and/or through the capillary layer is measured and from this, the concentration in the body fluid is ascertained. The sensor is preferably arranged as near to the sampling point as possible, but outside the body when positioned.

Although forming it with an integrated sensor, as an electrode platform and as an electrode platform with an integrated sensor are particularly advantageous in combination with the micro perfusion device in accordance with the invention, each of these formations, in particular forming an electrode on the lower side of a casing, can also be realized with all conventional devices which may be used to obtain at least constituent of body fluid and include a cannula for positioning in a body tissue.

### BRIEF DESCRIPTION OF THE DRAWINGS

FIG. 1 depicts a micro perfusion device comprising transport by evaporation, and FIG. 1a is an enlarged view of a portion of FIG. 1;

FIG. 2 depicts the device in accordance with FIG. 1, comprising a connected suction means;

FIG. 3, including FIGS. 3a-c, depicts inner cannulae with non-circular outer cross-sections;

FIG. 4, including FIGS. 4a-c, depicts outer cannulae with non-circular inner cross-sections;

FIG. 5 depicts a micro filtration device comprising transport by evaporation; and

FIG. 6 depicts the device in accordance with FIG. 5, comprising a connected suction means.

### DETAILED DESCRIPTION

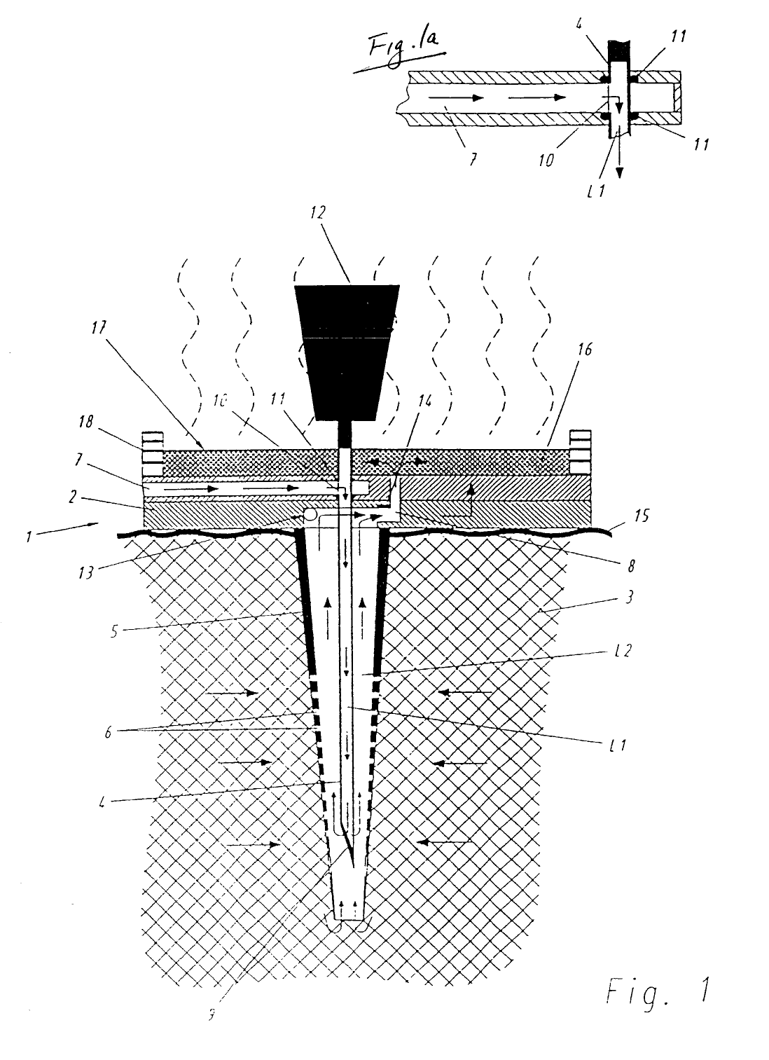

FIG. 1 shows an implanted micro perfusion device in a longitudinal section. The device comprises a casing 1 with a bearing disc 2, onto the lower side of which an adhesive patch 15 is attached. A flexible, perforated cannula 5 projects generally perpendicularly from the lower side of the bearing disc 2. The cannula 5 concentrically surrounds an inner cannula 4 protruding into it. The cannula 5 will be referred to in this description as the outer cannula. The inner cannula 4 is formed as an injection needle. It is formed in the manner of injection needles such as those that are known from catheter heads for infusing insulin. The inner cannula 4 is formed by a slim, straight hollow cylinder having a front cannula opening 9 at its distal, front facing end and a rear cannula opening 10 in the surface of the inner cannula 4. The inner cannula 4 does not comprise any other openings. The inner cannula 4 encloses an inner lumen L1 between its two openings 9 and 10. An outer lumen L2, in the form of an annular gap, is formed between the inner cannula 4 and the outer cannula 5. The outer cannula 5 is connected to the casing 1, fluid-proof.

In the casing 1, a fluid outlet in the form of a discharge channel 8 and a perfusate supply in the form of a supply channel 7 are formed in the bearing disc 2. The inner cannula 4 is accommodated slidably in the casing 1, guided in a straight line in the longitudinal direction. The linear guide is formed by a through-bore which projects through the casing 1 from an upper side to the opposite lower side. In this way, the inner cannula 4 projects through both the supply channel 7 and the discharge channel 8. In the supply channel 7, two sealing rings 11 are inserted into two recesses, each encircling the through-bore in the inner wall of the supply channel 7, said sealing rings 11 surrounding the inner cannula 4 in a pressure force seal. In a rear sliding position of the inner cannula 4, shown, the rear cannula opening 10 comes to rest between the two sealing rings 11. In this way, a fluid-proof connection between the supply channel 7 and the inner lumen L1 is created in the rear sliding position of the inner cannula 4, and the supply channel 7 and discharge channel 8 are constantly separated, fluid-proof In the rear sliding position of the inner cannula 4, the sealing rings 11 simultaneously establish a locking connection between the inner cannula 4 and the casing 1. In the locking position, i.e., in the rear sliding position, the two sealing rings 11 are pressed into the rear cannula opening 10. In this way, a locking or latching effect is achieved. The rear cannula opening 10 extends in the longitudinal direction of the inner cannula 4 over such a length that both sealing rings 11 come to rest in the rear cannula opening 10 and one each of the two sealing rings 11 presses on a rear and a front opening rim, respectively. For providing the locking connection, it would in principle be sufficient if only one of the sealing rings 11 came to rest behind the rear or front rim of the rear cannula opening 10, in the rear sliding position. However, pressing against both the rear rim and against the opposite, front opening rim of the rear cannula opening 10 creates a locking connection which prevents the inner cannula 4 from being unintentionally slid in either sliding direction. The fluid connection between the supply channel 7 and the inner cannula 4, as well as the locking connection between the casing 1 and the inner cannula 4, are shown again in a separate, enlarged detail in FIG. 1a.

In order to facilitate manually sliding the inner cannula 4, the inner cannula 4 is provided with a cannula grip 12 on its rear end protruding out of the casing 1.

FIG. 1 shows the micro perfusion device in its operational state during micro perfusion, wherein the inner cannula 4 is situated in its rear sliding position in the casing 1. Before the outer cannula 5 is implanted or positioned in the tissue 3, the inner cannula 4 projects through the outer cannula 5 in a front sliding position. In this initial state, the tip of the inner cannula 4 including the front cannula opening 9 lies beyond the front end of the outer cannula 5. In this initial state, the cannula grip 12 is pressed up against the surface of the casing 1. In order to position the outer cannula 5, the inner cannula 4 and the outer cannula 5, which at least at its front end wraps around the inner cannula 4, are pierced through the skin and inserted into the tissue 3, up to the position shown in FIG. 1. In this position, the bearing disc 2 of the casing 1 lies flat on the skin via its lower side. The adhesive patch 15 attached to the lower side of the bearing disc 2 forms an adhesive area with the skin. By pressing the casing 1 against the skin, an adhesive connection is established. In order to perform micro perfusion, the inner cannula 4 is retracted to the rear sliding position shown in FIG. 1, once the casing 1 has been positioned and attached. The micro perfusion device is then ready for micro perfusion to be performed, in order to obtain at least one constituent of the body fluid.

The outer cannula 5 is perforated with perforation openings 6 in a surface area between its front distal end and its rear proximal end bordering the casing 1. On its facing side, the outer cannula 5 opens forwards. When the outer cannula 5 is rinsed, so-called open flow micro perfusion arises. A perfusate is guided through a connected supply catheter into the supply channel 7 of the casing 1, enters the hollow inner cannula 4 through the rear cannula opening 10, flows through the inner cannula 4 and emerges into the outer cannula 5 through the front distal cannula opening 9 at the tip of the cannula. Having emerged, the perfusate in the outer lumen L2 between the outer surface of the inner cannula 4 and the outer cannula 5 flows back towards the casing 1. As the perfusate flows back, body fluid F is suctioned in through the perforation openings 6 due to a resultant jet effect in the outer lumen L2 and carried along in the back flow of perfusate, and selectively, the body fluid constituent to be obtained or a number of body fluid constituents are absorbed through the perforation openings 6 due to a concentration gradient between the body fluid F and the perfusate and carried along in the back flow of perfusate. The perfusate flowing back passes from the outer lumen L2 into the discharge channel 8 via a fluid connection formed in the casing 1 and then enters a capillary layer 16.

The capillary layer 16 is formed as a fleece. Due to capillary rise, the capillary layer 16 sucks itself full of the entering or infiltrating fluid. The capillary layer 16 exhibits a surface 17 which is exposed towards the environment, at which fluid comes into direct contact with the environment and evaporates. The exposed surface 17 will therefore be referred to as the evaporation area. In order to design the flow path for the fluid flowing back to be as short as possible, the capillary layer 16 is attached directly to the surface of the casing 1, for example, adhered to it.

In principle, the capillary layer 16 and in particular the evaporation area 17 should be arranged as near as possible to the surface of the skin, in order—alongside the short transport paths cited—to also have maximally constant evaporation conditions, in particular maximally even temperatures.

A precondition of transporting by evaporation in accordance with the invention is that a continuous column of fluid is formed in the flow system, i.e., from the supply 7 to the capillary layer 16. In principle, the column of fluid only has to be provided up until the fluid to be transported enters the capillary layer 16, since once it enters the capillary layer 16, capillary rise transports it on. Not least for the purpose of easier functional control, the column of fluid is preferably formed up to the evaporation area. In the course of initial priming, the continuous column of fluid can be actively or passively formed. Alternatively, the entire device from the supply channel 7 to the evaporation area 17 can be filled by the manufacturer with a sterile, bio-compatible fluid, such that transport by evaporation is employed immediately after the device has been subcutaneously positioned.

In the case of passive priming, the continuous column of fluid is automatically formed by designing the fluid-guiding components of the device in such a way that the body fluid is automatically suctioned by adhesion forces and regulates the uninterrupted column of fluid itself.

In the case of active priming, a continuous column of fluid is formed by suctioning the body fluid or tissue fluid. It can be suctioned, for example, by expanding a flexible container connected to the capillary layer 16. In the case of a micro perfusion device, the perfusate can also be pressured up to the capillary layer 16, to form an initial continuous column of fluid.

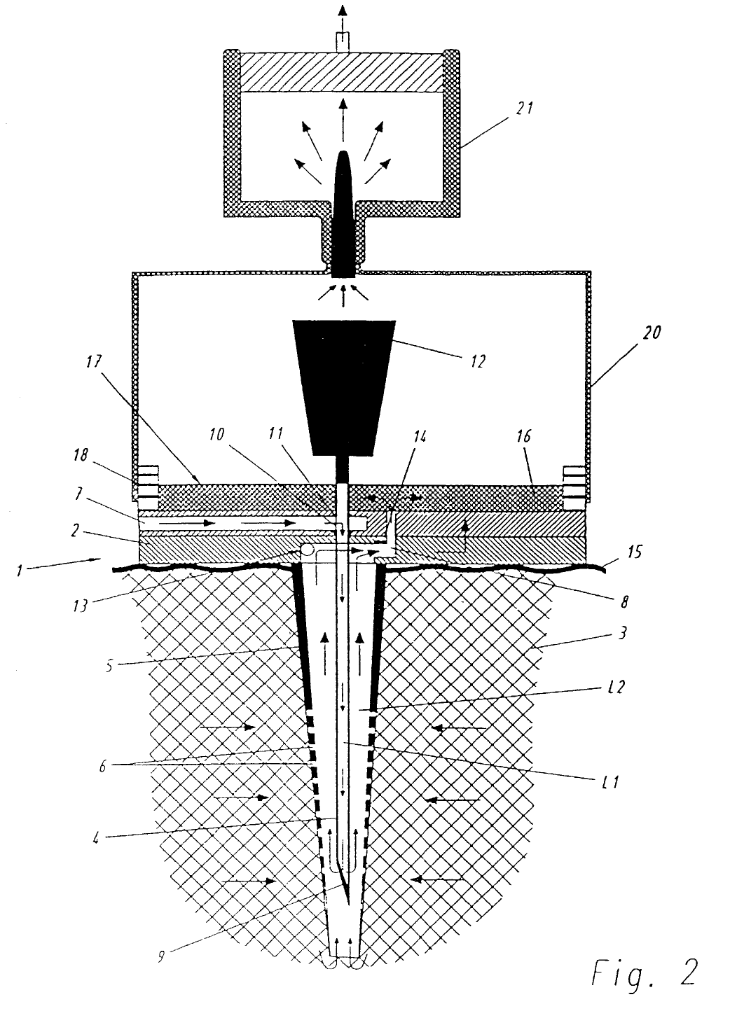

FIG. 2 shows the micro perfusion device of FIG. 1, during active priming. To this end, the casing 1 is connected to a suction means 21. Using the suction means 21, a space is evacuated, or at least partially evacuated, which comprises the evaporation area 17 as a limiting area. The connection between the casing 1 and the suction means 21 is formed by an adapter 20 formed as a vessel, which is placed over the evaporation area 17 like a bell, preferably air-tight. In one embodiment, the adapter 20 is screwed onto the casing 1 such that the adapter 20 encloses the entire capillary layer 16 air-tight. In order to connect to the adapter 20, the casing 1 is provided with a thread 18 which surrounds the capillary layer 16.

The adapter 20 has a fluid connection to the suction means 21. The suction means 21 can be formed, for example, by a conventional syringe. In principle, however, any type of pump for generating a partial vacuum in the space enclosed by the adapter 20 and the evaporation area 17 can be used.

In the casing 1, a miniature sensor 13 is arranged in a flow cross-section of the perfusate flowing back. The sensor 13 is arranged in the discharge channel 8 in the casing 1, in a flow cross-section immediately downstream of the outer cannula 5. The sensor 13 is not, however, implanted. It is situated in a flow cross-section as near as possible to the body, i.e., as near as possible to the sampling point, but outside the tissue 3. In one embodiment, the sensor 13 can still be inserted, for example clipped, into the casing 1 subsequently, i.e., after the micro perfusion device has been positioned.

The micro perfusion device serves not only as a sensor platform, but simultaneously also serves as an electrode platform for a measuring means. A working electrode 14 is formed in the casing 1 on an inner wall of the discharge channel 8 or forms an area of the inner wall. The adhesive patch 15 is itself electrically conductive and is electrically connected to the skin. It serves the measuring means as a counter electrode to the working electrode 14. The bearing area of the adhesive patch 15 is preferably sufficiently large that it also simultaneously forms a reference electrode.

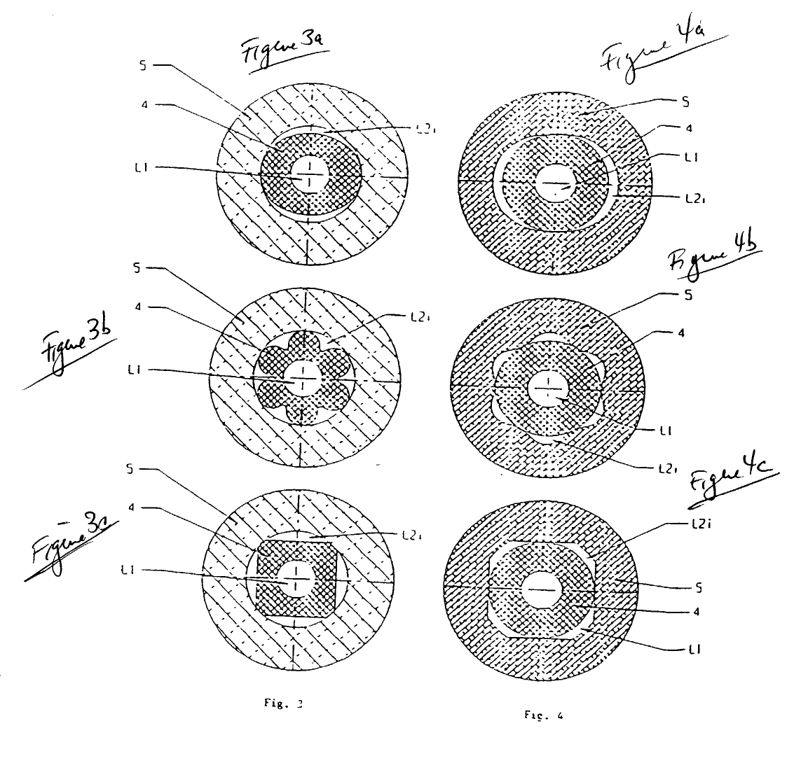

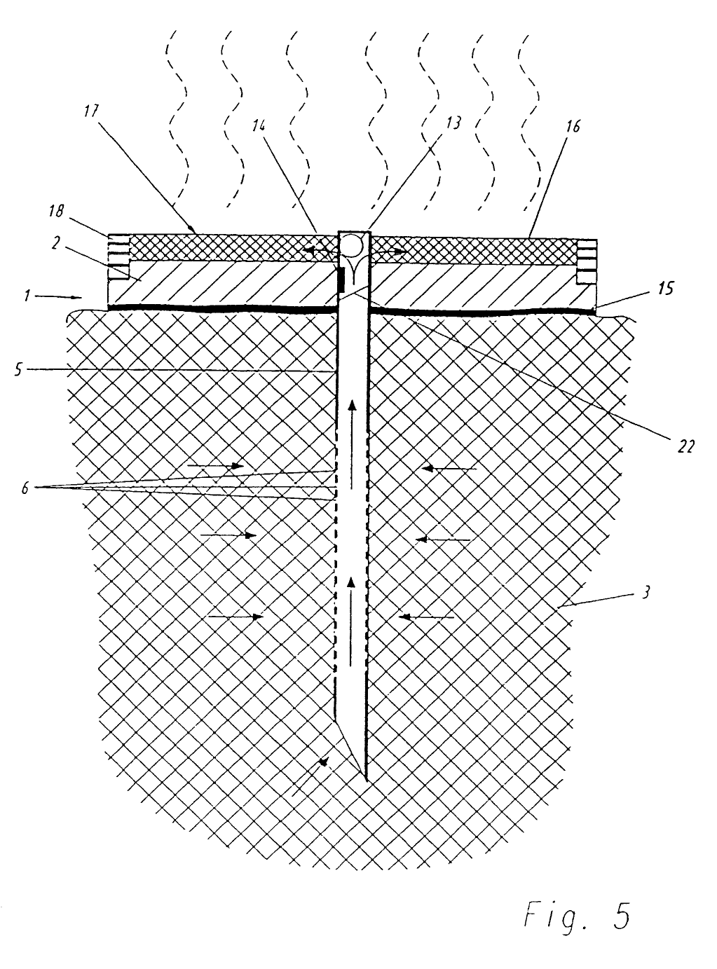

FIG. 3, including FIGS. 3a-c, and FIG. 4, including FIGS. 4a-c, show combinations of inner cannulae, namely injection needles 4, and outer cannulac 5, whose cross-sectional shapes are respectively adapted to each other such that a sufficient flow cross-section or passage always remains in the outer lumen L2 over the entire flow length of the fluid flowing back, and the outer cannula 5 nonetheless tightly surrounds or wraps around the injection needle 4. In the cross-section combinations in FIG. 3, the inner cross-section of the outer cannula 5 in each case is circular in its neutral, untensed state, while the outer cross-section of the injection needle 4 deviates from the circular cross-sectional shape. In the cross-section combinations in FIG. 4, by contrast, the outer cross-section of the injection needle 4 is circular, and the inner cross-section of the outer cannula 5 deviates from the circular form. When installed, the outer cannula 5 is also tensed around the injection needle in its neutral state. In this way, partial lumens L2i through which the perfusate can flow back are formed along and distributed around the injection needle 4, between the points at which the outer cannula 5 presses on the injection needle 4. By forming the outer cross-section of the injection needle 4 and the inner cross-section of the outer cannula 5 such that the outer cannula 5 only presses on the injection needle 4 in longitudinal strips and partial lumens 2Li remain between the pressure strips, the outer cannula 5 can be tensed around the injection needle 4 over its entire implanted length or at least over a front, partial length. The injection needle 4 thus supports the outer cannula 5, which is advantageous when piercing the skin and inserting it further into the tissue.

FIG. 5 shows a micro filtration device in a longitudinal section. The device comprises a cannula 5 subcutaneously positioned in a tissue 3, in a longitudinal section. The cannula 5 is formed by an injection needle. The cannula 5 comprises a perforated cannula surface comprising perforation openings 6 like the outer cannula 5 of the micro perfusion device in FIGS. 1 and 2.

The device comprises a casing 1 which is substantially formed by a bearing disc 2 alone. An adhesive patch 15 is again attached to the lower side of the bearing disc 2, said adhesive patch 15 serving to fix the device on the surface of the skin. The cannula 5 is held in the bearing disc 2 in a through-opening or through-bore. The cannula 5 also protrudes through the bearing disc 2 on its upper side. Furthermore, a thread 18 is formed on the bearing disc 2, for attaching an adaptor for a suction means.

As in the examplary embodiment of the micro perfusion device, a capillary layer 16, for example a fleece or a textile fabric, is arranged on the upper side of the bearing disc 2, for example adhered flat to it. The capillary layer 16 extends substantially over the entire upper side of the bearing disc 2, as also in the examplary embodiment of the micro perfusion device.

The cannula 5 protrudes into the capillary layer 16. The inner lumen of the cannula 5 has a fluid connection to the capillary layer 16. In one embodiment, the surface of the cannula 5 is permeable in the section in which there is contact with the surrounding capillary layer 16.

The casing 1 of the micro filtration device does not comprise any supply or discharge channels. Fluid is transported exclusively through the cannula 5 directly into the capillary layer 16. A valve 22 is arranged in a section of the cannula 5 outside the tissue 3 and in the flow path of the suctioned fluid, before the capillary layer 16, said valve 22 preventing the suctioned fluid from flowing back towards the tissue 3. A valve having such a function is preferably arranged in the flow path, outside the body tissue, in a device in accordance with the invention.

Furthermore, a sensor 13 is arranged in the cannula 5 outside the tissue 3, said sensor corresponding to the sensor 13 of the micro perfusion device of FIGS. 1 and 2. Furthermore, a working electrode 14 is arranged in the cannula 5, said working electrode corresponding to the working electrode 14 of the micro perfusion device of FIGS. 1 and 2. The operation of the micro filtration device with respect to the sensor 13 and the electrodes 14 and 15 is identical to the same components of the micro perfusion device of FIGS. 1 and 2. The sensor 13 and the working electrode 14 are arranged downstream of the valve 22.

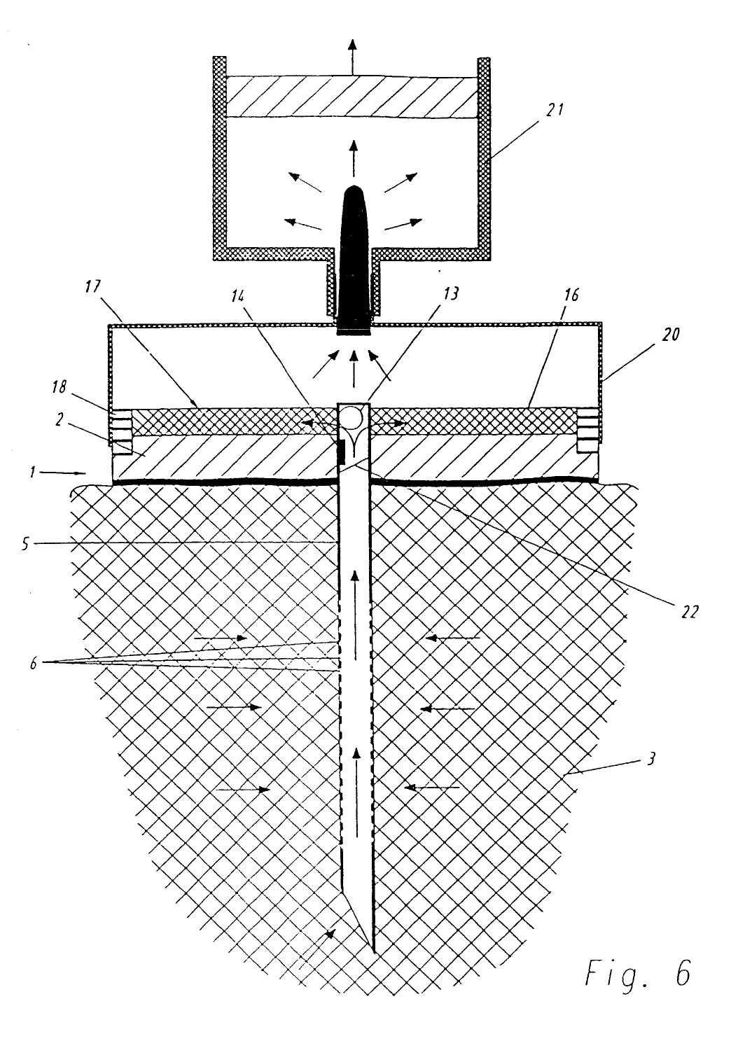

In the case of active priming, shown in an example in FIG. 6, a vacuum or partial vacuum is again generated over the evaporation area 17 by means of a suction means 21. As also in the case of the micro perfusion device of FIGS. 1 and 2, the suction means 21 is connected by screws to the casing 1 by means of a bell-like adaptor 20 or an adaptor 20 formed as a vessel. With respect to active priming, that which has already been said with respect to the micro perfusion device applies, although a continuous column of fluid need only be formed in the cannula 5 up until the fluid enters the capillary layer 16.

As soon as a continuous column of fluid has been formed in the cannula 5 up until into the capillary layer 16, the suction means 21 and the adaptor 20 can be removed, since capillary rise is then already being used. The column of fluid is preferably formed up to the evaporation area 17. Transport by capillary rise in the capillary layer 16, based on evaporating the suctioned fluid, is kept going by ongoing evaporation at the evaporation area 17.

In principle, evaporation can be further increased as compared to basic contact with the environment, by means of the suction means 21 or by generating a permanent partial vacuum within the sealed space over the evaporation area 17. This applies to micro perfusion and micro filtration. However, exposed natural evaporation is perfectly sufficient and for the user in particular is substantially more comfortable.

In the foregoing description, embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A device for obtaining at least one constituent of a body fluid, using a cannula which projects from a lower side of said device and may be positioned in a body tissue, wherein:
a) said device comprises a capillary layer having an exposed surface for evaporating said fluid; and
b) said cannula is connected to said capillary layer.

2. The device as set forth in claim 1, wherein said capillary layer comprises capillaries for transporting fluid to said exposed surface, said capillaries extending through said capillary layer generally perpendicularly to said exposed surface.

3. The device as set forth in claim 1, wherein said capillary layer comprises capillary channels extending at said exposed surface.

4. The device as set forth in claim 1, wherein said capillary layer comprises a fabric-like material

5. The device as set forth in claim 1, wherein said capillary layer contains a fabric.

6. The device as set forth in claim 1, wherein said capillary layer contains a fleece.

7. The device as set forth in claim 1, wherein said device is filled with a sterile, bio-compatible fluid before it is subcutaneously positioned.

8. The device as set forth in claim 1, wherein:
said device comprises a casing;
said cannula projects from a lower side of said casing; and
said capillary layer is associated with an upper side of said casing.

9. The device as set forth in claim 8, wherein said capillary layer is attached to the upper side.

10. The device as set forth in claim 8, wherein said capillary layer is formed integrally with said casing.

11. The device as set forth in claim 8, wherein said casing is connectable to a vessel which may be evacuated, such that said vessel encloses said exposed surface of said capillary layer and such that a space enclosed by said exposed surface and said vessel may be evacuated.

12. The device as set forth in claim 1, wherein:
said device is a micro perfusion device;
a casing of said device comprises a supply for a fluid perfusate;
said cannula projects from a lower side of said casing and when positioned for micro perfusion forms an outer cannula which surrounds an inner cannula;
said inner cannula forms an inner lumen between a front cannula opening which is distal with respect to said casing and a rear cannula opening, said inner lumen being connected or connectable to said supply via said rear cannula opening; and
an outer lumen remains between said inner cannula and said outer cannula which is connected to said front cannula opening and said capillary layer.

13. The device as set forth in claim 12, wherein:
said inner cannula has a longitudinal axis and is accommodated by said casing such that it may be slid from a front sliding position to a rear sliding position in the longitudinal direction; and
said inner cannula is an injection needle, which in its front sliding position protrudes out of said outer cannula and in its rear sliding position said outer cannula protrudes beyond it.

14. The device as set forth in claim 12, wherein said supply is connected to a variable-volume storage container for a perfusate.

15. The device as set forth in claim 14, wherein said storage container is flexible.

16. The device as set forth in claim 1, wherein said device is a micro filtration device.

17. The device as set forth in claim 1, wherein a sensor of a measuring means for measuring the concentration of said at least one constituent of said body fluid is arranged in a section of said device which said body fluid flows through, wherein after positioning the device, said section extends outside said body tissue from said cannula up to and including said exposed surface of said capillary layer.

18. The device as set forth in claim 1, wherein:
a measuring means for measuring the concentration of said at least one constituent of said body fluid comprises a working electrode and a counter electrode; and
said counter electrode is formed on said lower side of said device which contacts the skin once said inner cannula and said perfusion cannula have been positioned.

19. The device as set forth in claim 1, wherein:
a measuring means for measuring the concentration of said at least one constituent of said body fluid comprises a working electrode and a counter electrode; and
said working electrode is arranged in a section of said device which said body fluid flows through, wherein after positioning the device, said section extends outside said body tissue from said cannula up to and including said exposed surface of said capillary layer.
